(19) United States
(12) Patent Application Publication
(10) Pub. No.: US 2007/0103891 A1
(43) Pub. Date: May 10, 2007

(54) Device for fixing a detachable lamp to a crash helmet

(76) Inventor: Adriaan Schot, Neuville Les Dames (FR)

Correspondence Address: FAY SHARPE LLP, 1100 SUPERIOR AVENUE, SEVENTH FLOOR, CLEVELAND, OH, 44114, US

(21) Appl. No.: 10/558,165

(22) PCT Filed: May 21, 2004
(86) PCT No.: PCT/FR04/01268

§ 371 Date: Nov. 20, 2006

(30) Foreign Application Priority Data
May 23, 2003 (FR) 03 06205

(51) Int. Cl. F21V 21/084; F21L 4/00

(52) U.S. Cl. 362/105; 362/191

(57) ABSTRACT

A fixing device (1) holds a detachable lamp (2) on a crash helmet (3). The fixing device (1) includes a support element (4) which is to be fixed to the crash helmet (3), and a catch element (5) can be fixed to the detachable lamp (2). The catch element can slide in a guiding track (10) provided on the support element (4). The sliding of the catch element is blocked at one end of the guiding track by a first stop (20). A second stop (30) blocks the sliding of the catch element at the other end of the guiding track. The catch element can be inserted into the guiding track in an engaging direction which is essentially perpendicular to the sliding direction of the catch element in the guiding track.

The present invention relates to a fixing device for holding a removable lamp on a protective helmet.

The invention is particularly advantageous, but not limited to, firemen's helmets.

In a certain number of applications, it can be important to attach in a nonpermanent way a removable lamp on an external surface of a protection helmet. Many users of this type of helmet regularly work in situations with little or no light. One thinks of firemen or soldiers, but also of construction workers, miners or speleologists.

To make a helmet usable with a removable lamp, the device needs a fixing device made up of a support element and an catching element. The support element is attached on one side of the helmet, while the catching element includes a sleeve to receive the lamp. In order to give the lamp its removable characteristic, the sleeve has a projecting member that is adapted to engage a horizontal guide slot of the support element. The engagement of this projecting member is carried out horizontally from back to front; the sliding movement of the catching element is only blocked towards the front.

However, this type of fixing device presents the disadvantage of not inhibiting sliding movement toward the rear such that the catching element can be caused very easily to disengage form the guide slot, in particular following an impact between the lamp and a foreign object. This is detrimental to the material itself, since the lamp can be damaged at the time of its fall, but also for the user who finds himself then without this means of personal lighting.

Additionally, the technical problem solved by the object of this invention, is to propose an attachment intended to keep a removable lamp on a helmet, the fixing device comprising a support element intended to be attached to a helmet and a catching element intended to be attached to the removable lamp, the catching element being adapted to slide in the guide rails disposed on the support element, the sliding of the catching element being blocked at one end of the guide means by the first blocking means, this fixing device which makes it possible to avoid problems by guaranteeing that the removable lamp will stay attached in the event of an impact, when the aforementioned impact is appreciably collinear with the direction of the sliding motion of the catching element in the support element.

The solution of the proposed technical problem is, according to the present invention, to have the fixing device comprise a second blocking means to block the sliding motion of the catching element at the other end of the guide means, and in which the catching element is adapted to be inserted in the guide means following a direction appreciably perpendicular to the direction of the sliding motion of the aforesaid catching element in the aforementioned guide means.

It is significant that the catching element is able to slide in the guide means between two extreme positions which are limited respectively by the first and second stops. In a particularly advantageous way, the catching element cannot be disengaged at the time of its sliding motion in the guide means, contrary to its counterpart.

As the insertion of the catching element in the guide means is carried out in a direction substantially perpendicular to the direction of the sliding motion of the aforesaid catching element at the aforementioned guide means, the withdrawal of the removable lamp requires a movement much more complex than before. This movement breaks up into a first movement along the direction of the sliding motion, combined with a second movement perpendicular to the first and along the direction of insertion.

The invention, as is presently defined, thus presents the advantage of guaranteeing the maintenance of the removable lamp, in the event of an impact along a direction substantially collinear with the sliding motion direction. The disengagement of the lamp can be carried out only at the will of its user, after a sufficiently complex manipulation to prevent any accidental dissociation. The fixing device according to the invention thus constitutes a true safety system.

The present invention relates equally to the characteristics which will arise during the description which will follow, and which will be considered separately or to all their possible technical combinations.

Other characteristics and advantages of the invention will emerge from the description which will follow as well as the annexed drawings which are given only by way of nonrestrictive examples.

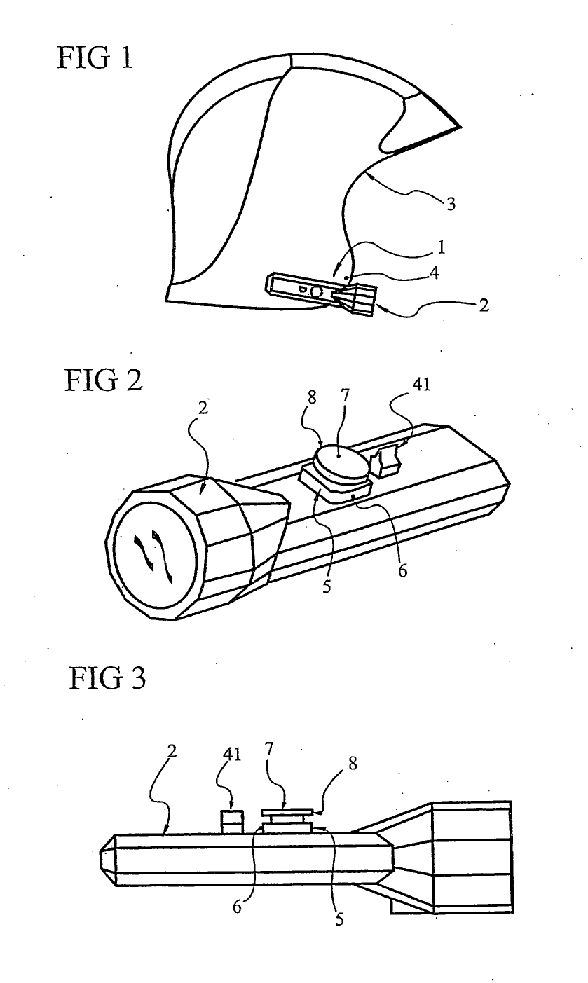

FIG. 1 is a side view illustrating a protective helmet on which a removable lamp is removably mounted by a fixing device according to the invention.

FIG. 2 shows the removable lamp of FIG. 1 in frontal perspective, the catching element being directly integrated into the body of the aforementioned removable lamp.

FIG. 3 shows a side view of the lamp in FIG. 2.

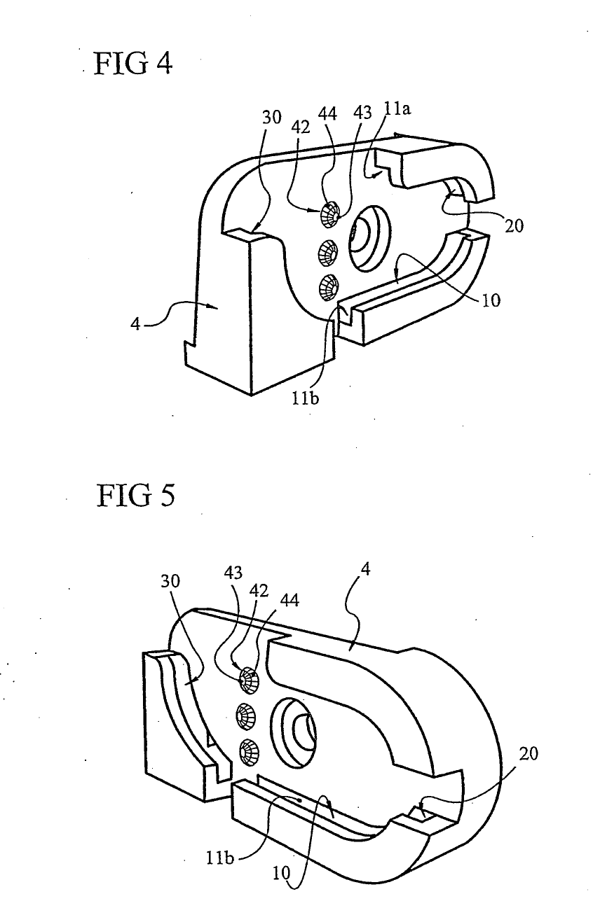

FIG. 4 is a rear perspective view of the support element forming part of the fixing device of FIG. 1.

FIG. 5 constitutes a frontal perspective view of the support element in FIG. 4.

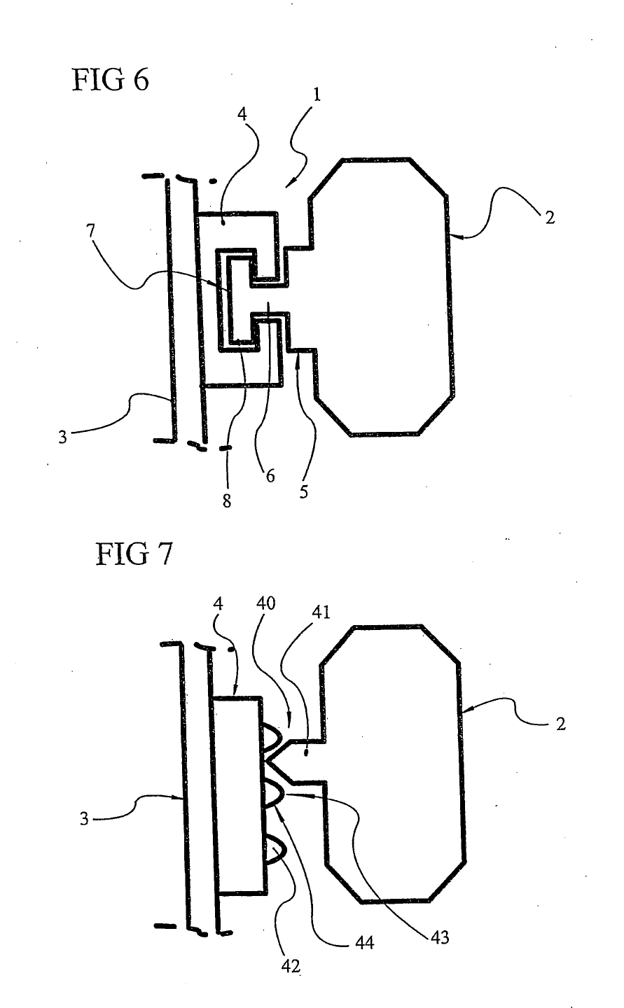

FIG. 6 is a cross-section illustrating diagrammatically the co-operation between the catching element and the support element composing the fixing device of FIG. 1.

FIG. 7 is a cross-section representing diagrammatically the means of indexing partially visible in FIGS. 2 to 5.

For reasons of clarity, like elements have been designated by identical reference numbers. Only the essential elements for the comprehension of the invention have been represented, and this without respect to scale and in a diagrammatic way.

FIG. 1 illustrates a fixing device 1 making it possible to maintain a removable lamp 2 on a protective helmet 3 of a fireman.

In this particular embodiment chosen only by way of example, the fixing device 1 is composed of a support element 4 attached on the side of the helmet 3, as well as a catching element 5 attached to the removable lamp 2. The catching element 5 is slidably mounted in horizontal guide means 10 on the support element 4; the sliding motion of the catching element 5 being blocked to the front by first stop 20.

In accordance with the object of this invention, the fixing device 1 comprises moreover a second stop 30 adapted to block any sliding motion towards the back of the catching element 5 in the guide means 10. Moreover, the catching element 5 is adapted to be inserted in the guide means 10 near the second stop 30, along a direction substantially perpendicular to the direction of sliding motion of the aforesaid catching element 5 in the aforementioned guide means 10.

As one can see in FIGS. 2 and 3, the catching element 5 is an integral part of the structure of the removable lamp 2. But, of course, one could envision an alternative in which the catching element 5 would include a sleeve able to temporarily receive the body of the removable lamp 2. In any event, the catching element 5 comprises a projecting member 6 at a free end 7 which is arranged orthogonally a shoulder 8 forming a shoe.

As FIGS. 4 and 5 show, the guide means 10 comprised of two parallel grooves 11a, 11b arranged horizontally in the support element 4, and on both sides of the direction of sliding motion of the catching element 5. The unit is arranged so that each guide slot 11a, 11b can cooperate with the sliding motion in at least a portion of the shoulder 8 of the catching element 5, in accordance with FIG. 6.

According to a characteristic of the invention, the catching element 5 is adapted to pivot at least partially on the guide means 10, along an orthogonal axis to the direction of sliding motion. In practice, the shoulder 8 in a circular form is able to slide longitudinally and to pivot orthogonally in the guide slots 11a, 11b. This is visible in FIGS. 2 and 3, which allow modification of the orientation of the lamp 2 relative to the helmet 3 along a vertical plane.

It can be advantageous to be able to gradually modify the inclination of the lamp 2, but also has to be able to benefit from a true immobilization of the aforementioned lamp in each position. According to another characteristic of the invention, the fixing device 1 comprises means of indexing 40 able to immobilize the pivoting of the catching element 5 along the guide means 10, in at least two predetermined inclinations with respect to the direction of the sliding motion.

In this embodiment, the means of indexing 40 comprises of a projecting element 41 and three embossings 42 respectively attached to the catching element 5 and the support element 4. In accordance with FIG. 7, the projecting element 41 is adapted to cooperate, on the one hand, by sliding over the free end 43 of each embossing 42, and in addition, by partially blocking the base 44 of each embossing 42. The displacement of the projecting element 41 by yielding to the embossings 42 is allowed by the play between the catching element 5 and the support element 4, and possibly by a certain elastic deformation of the unit. Of course, an alternative with at least one embossing 42 interdependent of the catching element 5 and at least one projecting element 41 attached to the support element 4 would be perfectly envisioned, but completely equivalent.

In accordance with FIGS. 4 and 5, the first stop 20 and the second stop 30 make up the projecting members respectively positioned on the direction of sliding motion at each end of the guide means 10. Each projecting member is thus adapted to cooperate with the catching element 5, by blocking movement along the direction of sliding motion.

In this method, the first stop 20 and the second stop 30 are attached to the support element 4. They are moreover both constituted by at least one projecting member having a form appreciably complementary to a portion of the shoulder 8 arranged on the catching element 5. Obviously, other forms fulfilling this same function could be adopted.

1. A fixing device intended to maintain a removable lamp on a helmet, the fixing device comprising a support element intended to be attached on the helmet and an catching element intended to be joined with of the removable lamp, the catching element being adapted to slide on guide means attached to the support element, the sliding motion of the catching element being blocked at the end of the guide means by a first stop, a second stop adapted to block the sliding motion of the catching element at the other end of the guide means, the catching element being adapted to be inserted in the guide means along a direction substantially perpendicular to the direction of sliding motion of the aforesaid catching element of the said guide means.

2. The fixing device according to claim 1, wherein the support element is adapted to be attached on a side of the helmet and the guide means are attached horizontally on the said support element, the sliding motion of the catching element being blocked towards the front by the first stop and blocked towards the rear by the second stop, the catching element adapted to be inserted in the guide means near the second stop.

3. The fixing device according to either one of claim 1, wherein the catching element comprises a projecting member at a free end which is orthogonally attached to a shoulder forming a shoe, guide means comprise two parallel grooves disposed facing each other along the direction of sliding motion, each guide slot being adapted to cooperate slidingly with at least a portion of shoulder.

4. The fixing device according to claim 1, wherein the catching element is adapted to pivot at least partially in the guide means, along an axis orthogonal to the direction of sliding motion.

5. The fixing device according to claim 4, wherein the shoulder presents a substantially circular form adapted to slide longitudinally and to pivot orthogonally in the guide rails.

6. The fixing device according to claim 1, further including a means of indexing adapted to immobilize the pivoting of the catching element in the guide means along at least two predetermined inclinations with respect to the direction of sliding motion.

7. The fixing device according to claim 6, wherein the means of indexing comprise at least one projecting element and at least one detent respectively disposed on the catching element and the support element, each projecting element being adapted to cooperate with each detent by sliding over a free end of the detent, by partially engaging a base of the detent.

8. The fixing device according to claim 1, wherein the catching element is an integral part of the removable lamp.

9. The fixing device according to claim 1, wherein the catching element includes of a sleeve adapted to receive a body of the removable lamp.

10. The fixing device according to claim 1, wherein the first stop and the second stop are attached to the support element.

11. The fixing device according to claim 1, wherein the first stop and the second stop comprise projecting members respectively positioned in the direction of sliding motion at each end of the guide means, each projecting member being adapted to cooperate with the catching element by blocking movement along to the direction of sliding motion.

12. The fixing device according to claim 1, wherein the first stop and the second stop both are constituted by at least one projecting member have a form substantially complementary to a portion of the catching element.

13. A helmet including a support element (4) claim 1.

14. A removable lamp for attachment to a helmet including a catching element according to claim 1.

15. An apparatus for removably attaching a lamp to a helmet, the apparatus comprising:
a support element disposed on the helmet, the support element including:
rails which define a longitudinal guide track,
a first stop blocking a forward end of the guide track, and
a second stop disposed adjacent a rearward end of the guide track to block downward and rearward movement and to permit upward movement;
a catching element disposed on the lamp, the catching element including:
a shoe configured to move downward and engage the second stop and to slide along the guide track into contact with the first stop.

16. The method according to claim 15 further including:
a projecting element and detent assembly for adjustably setting an angle of inclination of the lamp with respect to the helmet.
